(19) United States
(12) Patent Application Publication
(10) Pub. No.: US 2024/0425640 A1
(43) Pub. Date: Dec. 26, 2024

(54) THERMALLY CONDUCTIVE COMPOSITION

(71) Applicant: TATSUTA ELECTRIC WIRE & CABLE CO., LTD., Osaka (JP)

(72) Inventors: Tsuyoshi TSUDA, Kyoto (JP); Hajime NAKAZONO, Kyoto (JP); Norihiro YAMAGUCHI, Kyoto (JP)

(21) Appl. No.: 18/290,655

(22) PCT Filed: Aug. 25, 2022
(86) PCT No.: PCT/JP2022/032100

§ 371 Date: Jan. 19, 2024

(30) Foreign Application Priority Data
Aug. 25, 2021 (JP) 2021-137489

(51) Int. Cl. C08G 59/22; C08G 59/24; C08G 59/28; C08K 9/02; C09K 5/14

(52) U.S. Cl. CPC C08G 59/226; C08G 59/24; C08G 59/28; C08K 9/02; C09K 5/14; C08K 2201/001; C08K 2201/005

(57) ABSTRACT

A thermally conductive composition having excellent thermal conductivity, processability, and long-term reliability is provided. A thermally conductive composition contains: 100 parts by mass of an epoxy resin containing 1 to 30 parts by mass of a dimer acid epoxy resin and 1 to 40 parts by mass of a liquid epoxy resin (excluding dimer acid epoxy resins); and 700 to 1700 parts by mass of a conductive filler, in which the conductive filler contains a conductive filler (A) having an average particle size (D50) measured by a laser diffraction scattering particle size distribution measurement method of 5 to 20 μm and a conductive filler (B) having an average particle size (D50) of 1 to 8 μm, a rate ((A)/(B)) of the average particle size of the conductive filler (A) and the average particle size of the conductive filler (B) is 1.5 or more, and a content rate ((A)/(B)) of the conductive filler (A) and the conductive filler (B) by mass rate is 1.0 to 50.0.

### TECHNICAL FIELD

The present invention relates to a thermally conductive composition having excellent thermal conductivity, processability, and long-term reliability.

### BACKGROUND ART

Along with a reduction in size and an increase in density of semiconductor chips, an increase in heating value in semiconductor members is becoming a problem. Regarding such a problem, for example, PTL 1 describes using a composition having thermal conductivity.

However, due to an increasing demand from the market, a composition having a more excellent thermal conductivity is required.

As a method for increasing thermal conductivity, increasing a content of a conductive filler can be considered. However, when the content of the conductive filler is increased, a viscosity of the thermally conductive composition may increase and processability (printability) may deteriorate. Meanwhile, as a method for decreasing the viscosity of the thermally conductive composition, a method of adding solvent can be considered. However, when the thermally conductive composition is cured, the solvent may evaporate to form voids in a cured product. When voids are formed in the cured product, a contact between conductive fillers may be inhibited to deteriorate thermal conductivity.

Namely, thermal conductivity and processability (printability) are properties of antinomy, and it is required to improve these properties with good balance.

In addition, when a thermally conductive composition is used as a material of semiconductor, it is required to give an excellent result in a long-term reliability test.

### CITATION LIST

### Patent Literature

PTL 1: JP2006-036931A

### SUMMARY OF INVENTION

### Technical Problem

The invention has been made in view of the above problems, and an object thereof is to provide a thermally conductive composition having excellent thermal conductivity, processability, and long-term reliability.

### Solution to Problem

The invention includes the embodiments as indicated below.

[1] A thermally conductive composition, containing: 100 parts by mass of an epoxy resin containing 1 to 30 parts by mass of a dimer acid epoxy resin and 1 to 40 parts by mass of a liquid epoxy resin (excluding dimer acid epoxy resins); and 700 to 1700 parts by mass of a conductive filler, in which the conductive filler contains a conductive filler (A) having an average particle size (D50) measured by a laser diffraction scattering particle size distribution measurement method of 5 to 20 μm and a conductive filler (B) having an average particle size (D50) of 1 to 8 μm, a rate ((A)/(B)) of the average particle size of the conductive filler (A) and the average particle size of the conductive filler (B) is 1.5 or more, and a content rate ((A)/(B)) of the conductive filler (A) and the conductive filler (B) by mass rate is 1.0 to 50.0.

[2] The thermally conductive composition according to [1], in which the dimer acid epoxy resin is a glycidyl-modified compound of a dimer acid.

[3] The thermally conductive composition according to [1] or [2], in which the liquid epoxy resin is a glycidyl ether epoxy resin.

[4] The thermally conductive composition according to any one of [1] to [3], in which the epoxy resin contains a glycidyl amine epoxy resin.

### Advantageous Effects of Invention

According to the thermally conductive composition of the invention, excellent thermal conductivity, processability, and long-term reliability can be obtained.

### BRIEF DESCRIPTION OF DRAWINGS

FIG. 1 is a schematic cross-sectional view of a sample board used in Examples.

### DESCRIPTION OF EMBODIMENTS

As described above, a thermally conductive composition according to the invention contains: 100 parts by mass of an epoxy resin containing 1 to 30 parts by mass of a dimer acid epoxy resin and 1 to 40 parts by mass of a liquid epoxy resin (excluding dimer acid epoxy resins); and 700 to 1700 parts by mass of a conductive filler, in which the conductive filler contains a conductive filler (A) having an average particle size (D50) measured by a laser diffraction scattering particle size distribution measurement method of 5 to 20 μm and a conductive filler (B) having an average particle size (D50) of 1 to 8 μm, a rate ((A)/(B)) of the average particle size of the conductive filler (A) and the average particle size of the conductive filler (B) is 1.5 or more, and a content rate ((A)/(B)) of the conductive filler (A) and the conductive filler (B) by mass rate is 1.0 to 50.0.

The use of the thermally conductive composition is not particularly limited, and the composition can be suitably used as a composition for filling vias formed on multilayer boards.

The dimer acid epoxy resin is an epoxy resin having one or more epoxy groups in the molecule thereof, and may be one obtained by modifying a dimer acid. Examples thereof include a glycidyl-modified compound of a dimer acid. Two or more types thereof may be used in combination. As such a resin, for example, one represented by the general formula (1) or (2) below may be used.

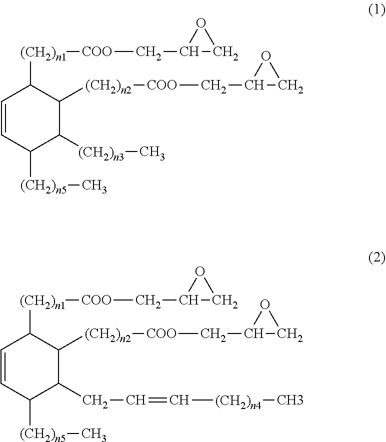

In the formulae (1) and (2), each of n1 to n5 individually represents an integer of 3 to 9.

n1 represents an integer of 3 to 9, preferably an integer of 4 to 8, more preferably 5 to 7, and particularly preferably 7. n2 represents an integer of 3 to 9, preferably an integer of 5 to 9, more preferably 7 or 8, and particularly preferably 7. n3 represents an integer of 3 to 9, preferably an integer of 4 to 8, more preferably 6 or 7, and particularly preferably 6. n4 represents an integer of 3 to 9. n5 represents an integer of 3 to 9, preferably an integer of 4 to 8, more preferably 5 or 6, and particularly preferably 5.

By containing such a dimer acid epoxy resin, the viscosity of the thermally conductive composition is easy to be decreased, and an excellent processability and an excellent fillability of vias formed on multilayer boards are easy to be obtained.

An epoxy equivalent of the dimer acid epoxy resin is not particularly limited, and is preferably 80 to 1500 g/eq and more preferably 200 to 1000 g/eq. When the epoxy equivalent falls within the above ranges, the thermally conductive composition having well-balanced heat resistance, viscosity, and adhesion is easy to be obtained.

A content of the dimer acid epoxy resin per 100 parts by mass of the epoxy resin is not particularly limited as long as it is 1 to 30 parts by mass, and is preferably 5 to 30 parts by mass. When the content of the dimer acid epoxy resin falls within the above ranges, an excellent processability is easy to be obtained.

The liquid epoxy resin (excluding dimer acid epoxy resins) is not particularly limited as long as it is a compound having one or more epoxy groups, and is preferably one having two or more epoxy groups in one molecule from the viewpoint of forming a three-dimensional crosslinked structure during curing. Specific examples of the liquid epoxy resin include bisphenol A type epoxy resins, brominated epoxy resins, bisphenol F type epoxy resins, novolac epoxy resins, alicyclic epoxy resins, glycidyl amine epoxy resins, glycidyl ether epoxy resins, glycidyl ester epoxy resins, and heterocyclic epoxy resins. Among these, glycidyl amine epoxy resins and glycidyl ether epoxy resins are preferred. These liquid epoxy resins may be used alone, or two or more types thereof may be mixed and used. In the present description, “liquid” means one having a fluidity at 25° C.

A viscosity (when two or more types are mixed, viscosity as a mixture) of the liquid epoxy resin (excluding dimer acid epoxy resins) at 25° C. is not particularly limited, and is preferably 50 mPa's or less, more preferably 30 mPa's or less, and further preferably 20 mPa's or less. When the viscosity falls within the above ranges, an excellent printability is easy to be obtained.

An epoxy equivalent of the liquid epoxy resin (excluding dimer acid epoxy resins) is not particularly limited, and is preferably 100 to 500 g/eq and more preferably 110 to 300 g/eq. When the epoxy equivalent falls within the above ranges, the thermally conductive composition having excellent heat resistance, viscosity, and thermal conductivity is easy to be obtained.

A content of the liquid epoxy resin (excluding dimer acid epoxy resins) per 100 parts by mass of the epoxy resin is not particularly limited as long as it is 1 to 40 parts by mass, and is preferably 5 to 40 parts by mass. When the liquid epoxy resin falls within the above ranges, an excellent processability is easy to be obtained.

The epoxy resin other than the dimer acid epoxy resin and the liquid epoxy resin (excluding dimer acid epoxy resins) may be one having one or more epoxy groups in the molecule thereof, and two or more types thereof may be used in combination. Specific examples thereof include bisphenol A type epoxy resins, brominated epoxy resins, bisphenol F type epoxy resins, novolac epoxy resins, alicyclic epoxy resins, glycidyl amine epoxy resins, glycidyl ester epoxy resins, and heterocyclic epoxy resins. Among these, one containing a glycidyl amine epoxy resin is preferred.

An epoxy equivalent of the epoxy resin other than the dimer acid epoxy resin and the liquid epoxy resin (excluding dimer acid epoxy resins) is not particularly limited, and is preferably 1500 g/eq or less and more preferably 20 to 1000 g/eq. When the epoxy equivalent falls within the above ranges, the thermally conductive composition having well-balanced heat resistance, viscosity, and adhesion is easy to be obtained.

By using the conductive filler (A) and the conductive filler (B), in which a rate ((A)/(B)) of the average particle sizes is 1.5 or more, the conductive filler (B) can fill gaps between the conductive fillers (A), and therefore the thermally conductive composition having an excellent thermal conductivity and having a low viscosity and an excellent processability is easy to be obtained.

A content of the conductive filler per 100 parts by mass of the epoxy resin is not particularly limited as long as it is 700 to 1700 parts by mass, and is preferably 1000 to 1700 parts by mass and more preferably 1200 to 1700 parts by mass. When the content falls within the above ranges, the thermally conductive composition having an excellent thermal conductivity and having a low viscosity and an excellent processability is easy to be obtained.

The content rate ((A)/(B)) of the conductive filler (A) and the conductive filler (B) by mass rate is not particularly limited as long as it is 1.0 to 50.0, and is preferably 1.5 to 30.0 and more preferably 2.0 to 25.0. When the content rate of the conductive filler (A) and the conductive filler (B) falls within the above ranges, an excellent thermal conductivity is easy to be obtained.

The conductive filler (A) and the conductive filler (B) are preferably copper powder, silver powder, gold powder, silver-coated copper powder, or silver-coated copper alloy powder. Among these, one type may be used alone, or two or more types may be used in combination. From the viewpoint of cost reduction, the fillers are more preferably copper powder, silver-coated copper powder, or silver-coated copper alloy powder.

A silver-coated copper powder includes a copper powder and a silver layer or silver-containing layer coating at least a part of the copper powder. A silver-coated copper alloy powder includes a copper alloy powder and a silver layer or silver-containing layer coating at least a part of the copper alloy powder. The copper alloy powder, for example, may contain 0.5 to 20% by mass of nickel and 1 to 20% by mass of zinc, with the remainder being copper, in which the copper of the remainder may contain inevitable impurities.

Examples of a shape of the conductive filler (A) include a flaky shape (a scaly shape), a dendritic shape, a spherical shape, a fibrous shape, and an amorphous shape (a polyhedron). From the viewpoint of obtaining a composition having a more reduced resistance value and a more improved thermal conductivity, it is preferably a spherical shape.

When the conductive filler (A) has a spherical shape, the conductive filler (A) preferably has a tap density of 3.5 to 7.0 g/cm³. When the tap density falls within the above range, thermal conductivity tends to be more favorable.

Examples of a shape of the conductive filler (B) include a flaky shape (a scaly shape), a dendritic shape, a spherical shape, a fibrous shape, and an amorphous shape (a polyhedron). From the viewpoint of obtaining a composition having a more reduced resistance value and a more improved thermal conductivity, it is preferably a spherical shape.

When the conductive filler (B) has a spherical shape, the conductive filler (B) preferably has a tap density of 4.0 to 7.0 g/cm³. When the tap density falls within the above range, thermal conductivity tends to be more favorable.

In the thermally conductive composition according to the invention, an epoxy resin curing agent can be used. Examples of the epoxy resin curing agent include a phenolic curing agent, an imidazolic curing agent, an aminic curing agent, and a cationic curing agent. One type thereof may be used alone, or two or more types thereof may be used in combination.

Examples of the phenolic curing agent include a phenol novolac and a naphthol compound.

Examples of the imidazolic curing agent include imidazole, 2-undecylimidazole, 2-heptadecylimidazole, 2-methylimidazole, 2-ethylimidazole, 2-phenylimidazole, 1-benzyl-2-phenylimidazole, 2-ethyl-4-methyl-imidazole, and 1-cyanoethyl-2-undecylimidazole.

Examples of the aminic curing agent include aliphatic polyamines such as diethylenetriamine and triethylenetetramine, and aromatic polyamines such as metaphenylenediamine, diaminodiphenylmethane, and diaminodiphenylsulfone.

Examples of the cationic curing agent include onium compounds represented by an amine salt of boron trifluoride, p-methoxybenzenediazonium hexafluorophosphate, diphenyliodonium hexafluorophosphate, triphenylsulfonium, tetra-n-butylphosphonium tetraphenylborate, tetra-n-butylphosphonium-o,o-diethylphosphorodithioate, and the like.

A content of the curing agent per 100 parts by mass of the epoxy resin is preferably 0.3 to 40 parts by mass and more preferably 0.5 to 35 parts by mass. When the content of the curing agent is 0.3 parts by mass or more, the thermally conductive composition sufficiently cures and the thermally conductive composition excellent in thermal conductivity is easy to be obtained. When the content is 40 parts by mass or less, the thermally conductive composition excellent in storage stability is easy to be obtained.

To the thermally conductive composition according to the invention, known additives such as a defoaming agent, a thickener, an adhesive, a filler, a fire retardant, and a coloring agent may be added to the extent not detrimental to the object of the invention.

The thermally conductive composition according to the invention preferably has a low viscosity from the viewpoint of easy applying to vias formed on multilayer boards by a dispensing method, an atmospheric printing method, and a vacuum printing method.

The dispensing method means a method of extruding the thermally conductive composition from a nozzle tip having a syringe shape to perform applying. The atmospheric printing method means a method of making a plate by using a plate with a chemical fiber screen stretched thereon as a stencil printing, optically forming a plate film on the screen, and sealing meshes except for the required drawn lines, and rubbing the thermally conductive composition under atmospheric pressure, via holes of the plate film, to a printed surface of a printing object set under the plate to perform printing. The vacuum printing method means a method of making a plate by using a plate with a chemical fiber screen stretched thereon as a stencil printing, optically forming a plate film on the screen, and sealing meshes except for the required drawn lines, and rubbing the thermally conductive composition under vacuum, via holes of the plate film, to a printed surface of a printing object set under the plate to perform printing.

A viscosity of the thermally conductive composition according to the invention is preferably adjusted appropriately in accordance with a use or a device used for applying, and is not particularly limited. As a general guide, when the temperature of the thermally conductive composition is 25° C., the viscosity is preferably 2800 dPa·s or less, more preferably 2500 dPa·s or less, and further preferably 2000 dPa·s or less. When it is 3000 dPa·s or less, a clogging of the nozzle in the dispensing method or a clogging of the screen in the printing methods is unlikely to occur, and an excellent fillability of vias formed on multilayer boards is easy to be obtained. A measurement method of the viscosity conforms to JIS K7117-1, and the viscosity can be measured using a single cylindrical rotational viscometer (so-called B-type or BH-type viscometer) and a rotor No. 7 at 10 rpm. It is not a problem when the viscosity is low, as long as it is measurable with the single cylindrical rotational viscometer.

It is preferred that the thermally conductive composition according to the invention contains no solvent from the viewpoint of preventing a generation of voids.

### EXAMPLES

The content of the invention will be described below in detail with reference to Examples, but the invention is not limited to the following Examples. In the following, “parts” and “%” are based on mass unless otherwise specified.

### EXAMPLES AND COMPARATIVE EXAMPLES

To 100 parts by mass of the epoxy resins indicated below were blended with conductive fillers and a curing agent by the ratios described in Tables 1 to 7, followed by mixing to obtain the thermally conductive compositions. Details of the components used are as the following.
Dimer acid epoxy resin: a resin in which, in the above-described formula (2), n1=7, n2=7, n4=4, and n5=5 was used.
Epoxy resin: glycidyl amine epoxy resin; “EP-3905S” manufactured by ADEKA CORPORATION; epoxy equivalent=95 g/eq
Liquid epoxy resin: glycidyl ether epoxy resin; “ED502” manufactured by ADEKA CORPORATION; epoxy equivalent=320 g/eq
Conductive filler (a): silver-coated copper particle; D50=22 μm; spherical shape
Conductive filler (b): silver-coated copper particle; D50=20 μm; spherical shape
Conductive filler (c): silver-coated copper particle; D50=18 μm; spherical shape
Conductive filler (d): silver-coated copper particle; D50=15 μm; spherical shape
Conductive filler (e): silver-coated copper particle; D50=14 μm; spherical shape
Conductive filler (f): silver-coated copper particle; D50=12 μm; spherical shape
Conductive filler (g): silver-coated copper particle; D50=10 μm; spherical shape
Conductive filler (h): silver-coated copper particle; D50=8 μm; spherical shape
Conductive filler (i): silver-coated copper particle; D50=6 μm; spherical shape
Conductive filler (j): silver-coated copper particle; D50=5 μm; spherical shape
Conductive filler (k): silver-coated copper particle; D50=4 μm; spherical shape
Conductive filler (l): silver-coated copper particle; D50=3 μm; spherical shape
Conductive filler (m): silver-coated copper particle; D50=2 μm; spherical shape
Conductive filler (n): silver-coated copper particle; D50=1 μm; spherical shape
Curing agent (a): imidazolic curing agent; “2E4MZ” manufactured by SHIKOKU KASEI HOLDINGS CORPORATION
Curing agent (b): phenol novolac type curing agent; “TAMANOL 758” manufactured by ARAKAWA CHEMICAL INDUSTRIES, LTD.

Evaluations of the thermally conductive compositions of Examples and Comparative Examples were performed as below. Results are shown in Tables 1 to 7.

### <Viscosity of Thermally Conductive Composition>

A viscosity at 25° C. of each of the thermally conductive compositions according to Examples and Comparative Examples was measured using a single cylindrical rotational viscometer (so-called B-type viscometer) and a rotor No. 7 at 10 rpm, conforming to JIS K7117-1.

### <Printability of Thermally Conductive Composition by Printing Method>

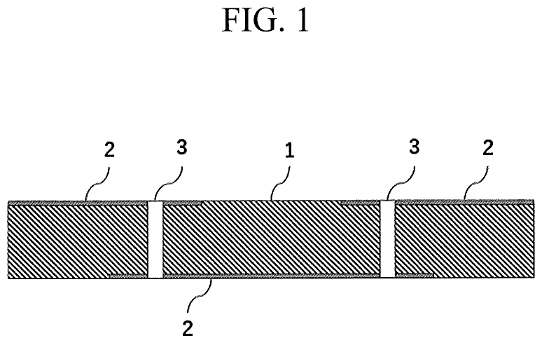

A sample for measurement was prepared by a printing method, using a sample board illustrated in FIG. 1. Specifically, through-holes having a hole diameter q of 0.15 mm are provided to a glass epoxy board having a thickness of 1.0 mm and having a copper patterning. In the through-holes, the thermally conductive composition prepared was filled by a printing method using a printer “LS-77A” manufactured by NEWLONG SEIMITSU KOGYO Co., LTD., followed by heating at 80° C. for 30 minutes and further heating at 160° C. for 30 minutes to prepare a sample by curing. The sample obtained was, before the curing and after the curing, subjected to an observation of via parts using an X-ray transmitter “Y.Cheetah μHD” manufactured by Yxlon International under the following measurement condition to confirm the presence or absence of voids. In addition, a cross section of the via part after the curing was observed and the presence or absence of peelings from a wall surface and cracks were observed. A sample in which no voids, no peelings from a wall surface, and no cracks occurred was evaluated as “A” as being excellent in printability. A sample in which at least one of a void, a peeling from a wall surface, and a crack occurred was evaluated as “B” as being poor in printability.

### <Printing Condition>

Printing pressure: 0.3 MPa
Squeegee angle: 15°
Squeegee speed: 10 mm/second
Clearance: 1.0 mm
Urethane squeegee hardness: 70

### <Measurement Condition>

Voltage: 50 kV
Current: 80 μA
Power: 4 W
   <Thermal Conductivity of Cured Product Obtained from Thermally Conductive Composition>

Each of the thermally conductive compositions according to Examples and Comparative Examples was printed on a Teflon (registered trademark) sheet using a bar film applicator (manufactured by BYK-Gardner). Thereafter, the thermally conductive composition was cured by heating at 160° C. for 60 minutes and peeled from the Teflon (registered trademark) sheet to obtain a cured product sample having a thickness of about 100 μm. The cured product sample prepared was evaluated for thermal conductivity using Thermowave Analyzer TA-35 (manufactured by BETHEL) conforming to JIS R7240. A thermal diffusivity α (m²/S) was measured using Thermowave Analyzer TA-35, and a thermal conductivity K (W/m·K) was calculated from the following formula (1) with a density p (kg/m³) and a specific heat Cp (J/Kg·K) of the cured product sample. When the thermal conductivity was 30 W/m·K or more, the sample was assessed to be excellent in heat dissipation.

Thermal conductivity K=thermal diffusivity α×density ρ×specific heat Cp (1)

Next, in the sample obtained by the printing method, excess cured product of the thermally conductive composition protruding above and below the through-holes was polished and removed to prepare an evaluation board, and long-term reliability was evaluated.

### <Initial Resistance Value>

A resistance value between both the ends of a coupling pattern on the sample board illustrated in FIG. 1 was measured using a milli-ohm tester. From the resistance value, a wiring resistance was subtracted, followed by dividing by the number of holes, to obtain a resistance value per one hole. As the wiring resistance, a resistance value was measured using a circuit board having the same design but no holes.

### <Long-Term Reliability 1 (Solder Dip Test)>

In a solder dip test, the evaluation board was dipped for 10 seconds in solder having been melted by heating at 260° C. This operation was repeated for three times. After the solder dip test, an observation of via parts and an observation of a cross section with an X-ray transmitter were performed, and a resistance value change rate was calculated.

(i) Observation of Via Parts and Observation of Cross Section with X-Ray Transmitter

Via parts were observed using an X-ray transmitter “Y.Cheetah μHD” manufactured by Yxlon International under the following measurement condition to confirm the presence or absence of voids. In addition, a cross section of the via part after the curing was observed and the presence or absence of peelings from a wall surface and cracks were observed. A board in which no voids, no peelings from a wall surface, and no cracks occurred was evaluated as “A” as being excellent in reliability. A board in which at least one of a void, a peeling from a wall surface, and a crack occurred after the reliability test was evaluated as “B” as being poor in reliability.

### <Measurement Condition>

Voltage: 50 kV
Current: 80 μA
Power: 4 W

### (ii) Resistance Value Change Rate

In the same manner as in the measurement of the initial resistance value, a resistance value between both the ends of a coupling pattern illustrated in FIG. 1 was measured after the reliability test. The initial resistance value before the reliability test was represented as “a” and the resistance value after the reliability test was represented as “b”. A resistance value change rate before and after the reliability test was calculated from the following formula. When the resistance value change rate was +20% or less, the sample was evaluated as excellent in reliability.

$$Resistance value change rate ( \% ) = ( b - a ) \times 100 / a$$

### <Long-term Reliability 2 (Heat Resistance Test)>

In a heat resistance test, each of the evaluation boards was left still for 1000 hours under an environment of an environmental temperature being 100° C. After the heat resistance test, similarly to the solder dip test, an observation of via parts and an observation of a cross section with an X-ray transmitter were performed, and a resistance value change rate was calculated.

### <Long-Term Reliability 3 (Humidity Resistance Test)>

In a humidity resistance test, each of the evaluation boards was left still for 1000 hours under an environment of an environmental temperature being 85° C. and a humidity being 85%. After the humidity resistance test, similarly to the solder dip test, an observation of via parts and an observation of a cross section with an X-ray transmitter were performed, and a resistance value change rate was calculated.

TABLE 1

| | | Comp. | | | | | | Comp. |
|---|---|---|---|---|---|---|---|---|
| | | Ex. 1 | Ex. 1 | Ex. 2 | Ex. 3 | Ex. 4 | Ex. 5 | Ex. 2 |
| Dimer acid epoxy resin | | 0 | 5 | 10 | 20 | 25 | 30 | 35 |
| Epoxy resin | | 70 | 70 | 65 | 60 | 55 | 55 | 55 |
| Liquid epoxy resin | | 30 | 25 | 25 | 20 | 20 | 15 | 10 |
| Curing agent (a) | | 5 | 5 | 5 | 5 | 5 | 5 | 5 |
| Curing agent (b) | | 15 | 15 | 15 | 15 | 15 | 15 | 15 |
| Conductive filler (f) | | 900 | 900 | 900 | 900 | 900 | 900 | 900 |
| Conductive filler (k) | | 400 | 400 | 400 | 400 | 400 | 400 | 400 |
| Total amount of conductive fillers | | 1300 | 1300 | 1300 | 1300 | 1300 | 1300 | 1300 |
| Rate ((A)/(B)) of average particle | | 3.0 | 3.0 | 3.0 | 3.0 | 3.0 | 3.0 | 3.0 |
| sizes of conductive filler (A) and | | | | | | | | |
| conductive filler (B) | | | | | | | | |
| Content rate ((A)/(B)) of conductive | | 2.3 | 2.3 | 2.3 | 2.3 | 2.3 | 2.3 | 2.3 |
| filler (A) and conductive filler (B) | | | | | | | | |
| Viscosity [dPa · s] | | 2960 | 2230 | 1830 | 1640 | 1580 | 1550 | 1530 |
| Printability | | B | A | A | A | A | A | A |
| Thermal conductivity [W/m · K] | | 22 | 34 | 39 | 42 | 40 | 35.0 | 19 |
| Initial resistance value [mΩ] | | 45 | 31 | 26 | 24 | 27 | 32.0 | 50 |
| Long-term | Resistance value | — | −3% | −5% | −6% | −5% | −6% | −4% |
| reliability 1 | change rate | | | | | | | |
| | Observation result | B | A | A | A | A | A | A |
| | of cross section | | | | | | | |
| Long-term | Resistance value | — | −6% | −2% | −4% | −3% | −7% | −4% |
| reliability 2 | change rate | | | | | | | |
| | Observation result | B | A | A | A | A | A | A |
| | of cross section | | | | | | | |
| Long-term | Resistance value | — | −2% | −9% | −7% | −10% | +9% | +24% |
| reliability 3 | change rate | | | | | | | |
| | Observation result | B | A | A | A | A | A | B |
| | of cross section | | | | | | | |

TABLE 2

| | | Comp. | | | | |
|---|---|---|---|---|---|---|
| | | Ex. 2-1 | Ex. 2-1 | Ex. 2-2 | Ex. 2-3 | Ex. 2-4 |
| Dimer acid epoxy resin | | 25 | 25 | 25 | 25 | 20 |
| Epoxy resin | | 75 | 70 | 65 | 60 | 60 |
| Liquid epoxy resin | | 0 | 5 | 10 | 15 | 20 |
| Curing agent (a) | | 5 | 5 | 5 | 5 | 5 |
| Curing agent (b) | | 15 | 15 | 15 | 15 | 15 |
| Conductive filler (f) | | 900 | 900 | 900 | 900 | 900 |
| Conductive filler (k) | | 400 | 400 | 400 | 400 | 400 |
| Total amount of conductive fillers | | 1300 | 1300 | 1300 | 1300 | 1300 |
| Rate ((A)/(B)) of average particle | | 3.0 | 3.0 | 3.0 | 3.0 | 3.0 |
| sizes of conductive filler (A) and | | | | | | |
| conductive filler (B) | | | | | | |
| Content rate ((A)/(B)) of conductive | | 2.3 | 2.3 | 2.3 | 2.3 | 2.3 |
| filler (A) and conductive filler (B) | | | | | | |
| Viscosity [dPa · s] | | 3600 | 2460 | 2030 | 1740 | 1640 |
| Printability | | B | A | A | A | A |
| Thermal conductivity [W/m · K] | | 32.0 | 34.0 | 40.0 | 41.0 | 42 |
| Initial resistance value [mΩ] | | 31 | 30 | 28 | 27 | 24 |
| Long-term | Resistance value | — | −18% | −23% | −12% | −6% |
| reliability 1 | change rate | | | | | |
| | Observation result | B | A | A | A | A |
| | of cross section | | | | | |
| Long-term | Resistance value | — | −17% | −19% | −11% | −4% |
| reliability 2 | change rate | | | | | |
| | Observation result | B | A | A | A | A |
| | of cross section | | | | | |
| Long-term | Resistance value | — | −8% | −6% | −7% | −7% |
| reliability 3 | change rate | | | | | |
| | Observation result | B | A | A | A | A |
| | of cross section | | | | | |
| | | | | | | Comp. |
| | | Ex. 2-5 | Ex. 2-6 | Ex. 2-7 | Ex. 2-8 | Ex. 2-2 |
| Dimer acid epoxy resin | | 20 | 20 | 20 | 15 | 15 |
| Epoxy resin | | 55 | 50 | 45 | 45 | 40 |
| Liquid epoxy resin | | 25 | 30 | 35 | 40 | 45 |
| Curing agent (a) | | 5 | 5 | 5 | 5 | 5 |
| Curing agent (b) | | 15 | 15 | 15 | 15 | 15 |
| Conductive filler (f) | | 900 | 900 | 900 | 900 | 900 |
| Conductive filler (k) | | 400 | 400 | 400 | 400 | 400 |
| Total amount of conductive fillers | | 1300 | 1300 | 1300 | 1300 | 1300 |
| Rate ((A)/(B)) of average particle | | 3.0 | 3.0 | 3.0 | 3.0 | 3.0 |
| sizes of conductive filler (A) and | | | | | | |
| conductive filler (B) | | | | | | |
| Content rate ((A)/(B)) of conductive | | 2.3 | 2.3 | 2.3 | 2.3 | 2.3 |
| filler (A) and conductive filler (B) | | | | | | |
| Viscosity [dPa · s] | | 1600 | 1540 | 1500 | 1430 | 1370 |
| Printability | | A | A | A | A | A |
| Thermal conductivity [W/m · K] | | 40 | 39 | 38.0 | 35.0 | 27.0 |
| Initial resistance value [mΩ] | | 26 | 28 | 28 | 28 | 35 |
| Long-term | Resistance value | −4% | −2% | +6% | +14% | +32% |
| reliability 1 | change rate | | | | | |
| | Observation result | A | A | A | A | B |
| | of cross section | | | | | |
| Long-term | Resistance value | −2% | −5% | +2% | +8% | +28% |
| reliability 2 | change rate | | | | | |
| | Observation result | A | A | A | A | B |
| | of cross section | | | | | |
| Long-term | Resistance value | −5% | −7% | −1% | +9% | +7% |
| reliability 3 | change rate | | | | | |
| | Observation result | A | A | A | A | A |
| | of cross section | | | | | |

TABLE 3

| | | Comp. | | | | | | | Comp. |
|---|---|---|---|---|---|---|---|---|---|
| | | Ex. 3-1 | Ex. 3-1 | Ex. 3-2 | Ex. 3-3 | Ex. 3-4 | Ex. 3-5 | Ex. 3-6 | Ex. 3-2 |
| Dimer acid epoxy resin | | 20 | 20 | 20 | 20 | 20 | 20 | 20 | 20 |
| Epoxy resin | | 60 | 60 | 60 | 60 | 60 | 60 | 60 | 60 |
| Liquid epoxy resin | | 20 | 20 | 20 | 20 | 20 | 20 | 20 | 20 |
| Curing agent (a) | | 5 | 5 | 5 | 5 | 5 | 5 | 5 | 5 |
| Curing agent (b) | | 15 | 15 | 15 | 15 | 15 | 15 | 15 | 15 |
| Conductive filler (f) | | 420 | 490 | 630 | 770 | 900 | 1050 | 1190 | 1260 |
| Conductive filler (k) | | 180 | 210 | 270 | 330 | 400 | 450 | 510 | 540 |
| Total amount of conductive fillers | | 600 | 700 | 900 | 1100 | 1300 | 1500 | 1700 | 1800 |
| Rate ((A)/(B)) of average particle | | 3.0 | 3.0 | 3.0 | 3.0 | 3.0 | 3.0 | 3.0 | 3.0 |
| sizes of conductive filler (A) and | | | | | | | | | |
| conductive filler (B) | | | | | | | | | |
| Content rate ((A)/(B)) of conductive | | 2.3 | 2.3 | 2.3 | 2.3 | 2.3 | 2.3 | 2.3 | 2.3 |
| filler (A) and conductive filler (B) | | | | | | | | | |
| Viscosity [dPa · s] | | 790 | 880 | 1110 | 1300 | 1640 | 2000 | 2470 | 3830 |
| Printability | | A | A | A | A | A | A | A | B |
| Thermal conductivity [W/m · K] | | 27.0 | 30.0 | 33.0 | 38.0 | 42 | 45.0 | 46.0 | 42.0 |
| Initial resistance value [mΩ] | | 39.0 | 33.0 | 29.0 | 26.0 | 24 | 21.0 | 20.0 | 22.0 |
| Long-term | Resistance value | −36% | −31% | −16% | −9% | −6% | −4% | −2% | — |
| reliability 1 | change rate | | | | | | | | |
| | Observation result | A | A | A | A | A | A | A | B |
| | of cross section | | | | | | | | |
| Long-term | Resistance value | −27% | −21% | −17% | −7% | −4% | −1% | +6% | — |
| reliability 2 | change rate | | | | | | | | |
| | Observation result | A | A | A | A | A | A | A | B |
| | of cross section | | | | | | | | |
| Long-term | Resistance value | −14% | −17% | −11% | −6% | −7% | −6% | −3% | — |
| reliability 3 | change rate | | | | | | | | |
| | Observation result | A | A | A | A | A | A | A | B |
| | of cross section | | | | | | | | |

TABLE 4

| | | Comp. | | | | |
|---|---|---|---|---|---|---|
| | | Ex. 4-1 | Ex. 4-1 | Ex. 4-2 | Ex. 4-3 | Ex. 4-4 |
| Dimer acid epoxy resin | | 20 | 20 | 20 | 20 | 20 |
| Epoxy resin | | 60 | 60 | 60 | 60 | 60 |
| Liquid epoxy resin | | 20 | 20 | 20 | 20 | 20 |
| Curing agent (a) | | 5 | 5 | 5 | 5 | 5 |
| Curing agent (b) | | 15 | 15 | 15 | 15 | 15 |
| Conductive filler (a) | | — | — | — | — | — |
| Conductive filler (b) | | — | — | — | — | — |
| Conductive filler (c) | | — | — | — | — | — |
| Conductive filler (e) | | — | — | — | — | — |
| Conductive filler (f) | | — | — | — | — | — |
| Conductive filler (g) | | — | — | — | — | 900 |
| Conductive filler (h) | | — | — | — | 900 | — |
| Conductive filler (i) | | — | — | 900 | — | — |
| Conductive filler (j) | | — | 900 | — | — | — |
| Conductive filler (k) | | 900 | — | 400 | 400 | 400 |
| Conductive filler (l) | | — | 400 | — | — | — |
| Conductive filler (m) | | 400 | — | — | — | — |
| Total amount of conductive fillers | | 1300 | 1300 | 1300 | 1300 | 1300 |
| Rate ((A)/(B)) of average particle | | 2.0 | 1.7 | 1.5 | 2.0 | 2.5 |
| sizes of conductive filler (A) and | | | | | | |
| conductive filler (B) | | | | | | |
| Content rate ((A)/(B)) of conductive | | 2.3 | 2.3 | 2.3 | 2.3 | 2.3 |
| filler (A) and conductive filler (B) | | | | | | |
| Viscosity [dPa · s] | | 3200 | 2480 | 2180 | 1960 | 1760 |
| Printability | | B | A | A | A | A |
| Thermal conductivity [W/m · K] | | 28.0 | 32.0 | 35.0 | 38.0 | 40.0 |
| Initial resistance value [mΩ] | | 36.0 | 34.0 | 29.0 | 26.0 | 25.0 |
| Long-term | Resistance value | — | −14% | −10% | −12% | −7% |
| reliability 1 | change rate | | | | | |
| | Observation result | B | A | A | A | A |
| | of cross section | | | | | |
| Long-term | Resistance value | — | −18% | −15% | −10% | −5% |
| reliability 2 | change rate | | | | | |
| | Observation result | B | A | A | A | A |
| | of cross section | | | | | |
| Long-term | Resistance value | — | −11% | −13% | −8% | −4% |
| reliability 3 | change rate | | | | | |
| | Observation result | B | A | A | A | A |
| | of cross section | | | | | |
| | | | | | | Comp. |
| | | Ex. 4-5 | Ex. 4-6 | Ex. 4-7 | Ex. 4-8 | Ex. 4-2 |
| Dimer acid epoxy resin | | 20 | 20 | 20 | 20 | 20 |
| Epoxy resin | | 60 | 60 | 60 | 60 | 60 |
| Liquid epoxy resin | | 20 | 20 | 20 | 20 | 20 |
| Curing agent (a) | | 5 | 5 | 5 | 5 | 5 |
| Curing agent (b) | | 15 | 15 | 15 | 15 | 15 |
| Conductive filler (a) | | — | — | — | — | 900 |
| Conductive filler (b) | | — | — | — | 900 | — |
| Conductive filler (c) | | — | — | 900 | — | — |
| Conductive filler (e) | | — | 900 | — | — | — |
| Conductive filler (f) | | 900 | — | — | — | — |
| Conductive filler (g) | | — | — | — | — | — |
| Conductive filler (h) | | — | — | — | — | — |
| Conductive filler (i) | | — | — | — | — | — |
| Conductive filler (j) | | — | — | — | — | — |
| Conductive filler (k) | | 400 | 400 | 400 | 400 | 400 |
| Conductive filler (l) | | — | — | — | — | — |
| Conductive filler (m) | | — | — | — | — | — |
| Total amount of conductive fillers | | 1300 | 1300 | 1300 | 1300 | 1300 |
| Rate ((A)/(B)) of average particle | | 3.0 | 3.5 | 4.5 | 5.0 | 5.5 |
| sizes of conductive filler (A) and | | | | | | |
| conductive filler (B) | | | | | | |
| Content rate ((A)/(B)) of conductive | | 2.3 | 2.3 | 2.3 | 2.3 | 2.3 |
| filler (A) and conductive filler (B) | | | | | | |
| Viscosity [dPa · s] | | 1640 | 1560 | 1430 | 1350 | 1300 |
| Printability | | A | A | A | A | A |
| Thermal conductivity [W/m · K] | | 42 | 41.0 | 38.0 | 36.0 | 28.0 |
| Initial resistance value [mΩ] | | 24 | 26.0 | 27.0 | 28.0 | 36.0 |
| Long-term | Resistance value | −6% | −10% | −8% | −2% | +7% |
| reliability 1 | change rate | | | | | |
| | Observation result | A | A | A | A | B |
| | of cross section | | | | | |
| Long-term | Resistance value | −4% | −6% | −8% | −4% | −6% |
| reliability 2 | change rate | | | | | |
| | Observation result | A | A | A | A | A |
| | of cross section | | | | | |
| Long-term | Resistance value | −7% | −12% | −9% | −7% | −10% |
| reliability 3 | change rate | | | | | |
| | Observation result | A | A | A | A | A |
| | of cross section | | | | | |

TABLE 5

| | | Comp. | | | | | Comp. |
|---|---|---|---|---|---|---|---|
| | | Ex. 5-1 | Ex. 5-1 | Ex. 5-2 | Ex. 5-3 | Ex. 5-4 | Ex. 5-2 |
| Dimer acid epoxy resin | | 20 | 20 | 20 | 20 | 20 | 20 |
| Epoxy resin | | 60 | 60 | 60 | 60 | 60 | 60 |
| Liquid epoxy resin | | 20 | 20 | 20 | 20 | 20 | 20 |
| Curing agent (a) | | 5 | 5 | 5 | 5 | 5 | 5 |
| Curing agent (b) | | 15 | 15 | 15 | 15 | 15 | 15 |
| Conductive filler (d) | | — | — | — | — | — | 900 |
| Conductive filler (f) | | 900 | 900 | 900 | 900 | 900 | — |
| Conductive filler (g) | | — | — | — | — | — | 400 |
| Conductive filler (h) | | — | — | — | — | 400 | — |
| Conductive filler (i) | | — | — | — | 400 | — | — |
| Conductive filler (k) | | — | — | 400 | — | — | — |
| Conductive filler (m) | | — | 400 | — | — | — | — |
| Conductive filler (n) | | 400 | — | — | — | — | — |
| Total amount of conductive fillers | | 1300 | 1300 | 1300 | 1300 | 1300 | 1300 |
| Rate ((A)/(B)) of average particle | | 12.0 | 6.0 | 3.0 | 2.0 | 1.5 | 1.5 |
| sizes of conductive filler (A) and | | | | | | | |
| conductive filler (B) | | | | | | | |
| Content rate ((A)/(B)) of conductive | | 2.3 | 2.3 | 2.3 | 2.3 | 2.3 | 2.3 |
| filler (A) and conductive filler (B) | | | | | | | |
| Viscosity [dPa · s] | | 3290 | 2400 | 1640 | 1430 | 1200 | 1130 |
| Printability | | B | A | A | A | A | A |
| Thermal conductivity [W/m · K] | | 27.0 | 34.0 | 42 | 40.0 | 35.0 | 24.0 |
| Initial resistance value [mΩ] | | 40.0 | 33.0 | 24 | 29.0 | 31.0 | 41.0 |
| Long-term | Resistance value | — | −10% | −6% | −8% | −5% | +4% |
| reliability 1 | change rate | | | | | | |
| | Observation result | B | A | A | A | A | A |
| | of cross section | | | | | | |
| Long-term | Resistance value | — | −11% | −4% | −6% | −2% | +1% |
| reliability 2 | change rate | | | | | | |
| | Observation result | B | A | A | A | A | A |
| | of cross section | | | | | | |
| Long-term | Resistance value | — | −9% | −7% | −8% | −2% | +4% |
| reliability 3 | change rate | | | | | | |
| | Observation result | B | A | A | A | A | A |
| | of cross section | | | | | | |

TABLE 6

| | | Comp. Ex. 6-1 | Ex. 6-1 |
|---|---|---|---|
| Dimer acid epoxy resin | | 20 | 20 |
| Epoxy resin | | 60 | 60 |
| Liquid epoxy resin | | 20 | 20 |
| Curing agent (a) | | 5 | 5 |
| Curing agent (b) | | 15 | 15 |
| Conductive filler (i) | | 900 | 900 |
| Conductive filler (j) | | 400 | — |
| Conductive filler (k) | | — | 400 |
| Total amount of conductive fillers | | 1300 | 1300 |
| Rate ((A)/(B)) of average particle | | 1.2 | 1.5 |
| sizes of conductive filler (A) and | | | |
| conductive filler (B) | | | |
| Content rate ((A)/(B)) of conductive | | 2.3 | 2.3 |
| filler (A) and conductive filler (B) | | | |
| Viscosity [dPa · s] | | 1930 | 2180 |
| Printability | | A | A |
| Thermal conductivity [W/m · K] | | 28.0 | 35.0 |
| Initial resistance value [mΩ] | | 38.0 | 31.0 |
| Long-term | Resistance value change rate | −8% | −10% |
| reliability 1 | Observation result of cross | A | A |
| | section | | |
| Long-term | Resistance value change rate | −11% | −15% |
| reliability 2 | Observation result of cross | A | A |
| | section | | |
| Long-term | Resistance value change rate | −10% | −13% |
| reliability 3 | Observation result of cross | A | A |
| | section | | |

TABLE 7

| | | Comp. | | | | | |
|---|---|---|---|---|---|---|---|
| | | Ex. 7-1 | Ex. 7-1 | Ex. 7-2 | Ex. 7-3 | Ex. 7-4 | Ex. 7-5 |
| Dimer acid epoxy resin | | 20 | 20 | 20 | 20 | 20 | 20 |
| Epoxy resin | | 60 | 60 | 60 | 60 | 60 | 60 |
| Liquid epoxy resin | | 20 | 20 | 20 | 20 | 20 | 20 |
| Curing agent (a) | | 5 | 5 | 5 | 5 | 5 | 5 |
| Curing agent (b) | | 15 | 15 | 15 | 15 | 15 | 15 |
| Conductive filler (f) | | 540 | 650 | 780 | 900 | 1040 | 1170 |
| Conductive filler (k) | | 760 | 650 | 520 | 400 | 260 | 130 |
| Total amount of conductive fillers | | 1300 | 1300 | 1300 | 1300 | 1300 | 1300 |
| Rate ((A)/(B)) of average particle | | 3.0 | 3.0 | 3.0 | 3.0 | 3.0 | 3.0 |
| sizes of conductive filler (A) and | | | | | | | |
| conductive filler (B) | | | | | | | |
| Content rate ((A)/(B)) of conductive | | 0.7 | 1.0 | 1.5 | 2.3 | 4.0 | 9.0 |
| filler (A) and conductive filler (B) | | | | | | | |
| Viscosity [dPa · s] | | 3490 | 2400 | 1860 | 1640 | 1530 | 1460 |
| Printability | | B | A | A | A | A | A |
| Thermal conductivity [W/m · K] | | 26.0 | 32.0 | 39.0 | 42 | 44.0 | 45.0 |
| Initial resistance value [mΩ] | | 41.0 | 33.0 | 27.0 | 24 | 22.0 | 20.0 |
| Long-term | Resistance value | — | −16% | −12% | −6% | −10% | −9% |
| reliability 1 | change rate | | | | | | |
| | Observation result | B | A | A | A | A | A |
| | of cross section | | | | | | |
| Long-term | Resistance value | — | −18% | −8% | −4% | −5% | −6% |
| reliability 2 | change rate | | | | | | |
| | Observation result | B | A | A | A | A | A |
| | of cross section | | | | | | |
| Long-term | Resistance value | — | −8% | −13% | −7% | −6% | −10% |
| reliability 3 | change rate | | | | | | |
| | Observation result | B | A | A | A | A | A |
| | of cross section | | | | | | |

| | | | | | | Comp. |
|---|---|---|---|---|---|---|
| | | Ex. 7-6 | Ex. 7-7 | Ex. 7-8 | Ex. 7-9 | Ex. 7-2 |
| Dimer acid epoxy resin | | 20 | 20 | 20 | 20 | 20 |
| Epoxy resin | | 60 | 60 | 60 | 60 | 60 |
| Liquid epoxy resin | | 20 | 20 | 20 | 20 | 20 |
| Curing agent (a) | | 5 | 5 | 5 | 5 | 5 |
| Curing agent (b) | | 15 | 15 | 15 | 15 | 15 |
| Conductive filler (f) | | 1196 | 1222 | 1248 | 1274 | 1287 |
| Conductive filler (k) | | 104 | 78 | 52 | 26 | 13 |
| Total amount of conductive fillers | | 1300 | 1300 | 1300 | 1300 | 1300 |
| Rate ((A)/(B)) of average particle | | 3.0 | 3.0 | 3.0 | 3.0 | 3.0 |
| sizes of conductive filler (A) and | | | | | | |
| conductive filler (B) | | | | | | |
| Content rate ((A)/(B)) of conductive | | 11.5 | 15.7 | 24.0 | 49.0 | 99.0 |
| filler (A) and conductive filler (B) | | | | | | |
| Viscosity [dPa · s] | | 1440 | 1420 | 1400 | 1370 | 1320 |
| Printability | | A | A | A | A | A |
| Thermal conductivity [W/m · K] | | 45.0 | 44.0 | 40.0 | 32.0 | 24.0 |
| Initial resistance value [mΩ] | | 21.0 | 20.0 | 24.0 | 34.0 | 42.0 |
| Long-term | Resistance value | −12% | −8% | −8% | −11% | −10% |
| reliability 1 | change rate | | | | | |
| | Observation result | A | A | A | A | A |
| | of cross section | | | | | |
| Long-term | Resistance value | −4% | −8% | −12% | −8% | −10% |
| reliability 2 | change rate | | | | | |
| | Observation result | A | A | A | A | A |
| | of cross section | | | | | |
| Long-term | Resistance value | −6% | −11% | −9% | −10% | −13% |
| reliability 3 | change rate | | | | | |
| | Observation result | A | A | A | A | A |
| | of cross section | | | | | |

According to the results shown in Table 1, when the content rate of the dimer acid epoxy resin fell within the predetermined range, results of the printability, thermal conductivity, and long-term reliability test were all excellent.

According to the results shown in Table 2, when the content rate of the liquid epoxy resin (excluding dimer acid epoxy resins) fell within the predetermined range, results of the printability, thermal conductivity, and long-term reliability test were all excellent.

According to the results shown in Table 3, when the total content of the conductive fillers fell within the predetermined range, results of the printability, thermal conductivity, and long-term reliability test were all excellent.

According to the results shown in Table 4, when the average particle size of the conductive filler (A) fell within the predetermined range, results of the printability, thermal conductivity, and long-term reliability test were all excellent.

According to the results shown in Table 5, when the average particle size of the conductive filler (B) fell within the predetermined range, results of the printability, thermal conductivity, and long-term reliability test were all excellent.

According to the results shown in Table 6, when the rate of the average particle sizes of the conductive filler (A) and the conductive filler (B) fell within the predetermined range, results of the printability, thermal conductivity, and long-term reliability test were all excellent.

According to the results shown in Table 7, when the content rate of the conductive filler (A) and the conductive filler (B) fell within the predetermined range, results of the printability, thermal conductivity, and long-term reliability test were all excellent.

### REFERENCE SIGNS LIST

1: Glass epoxy board
2: Copper
3: Via

1. A thermally conductive composition, comprising:
100 parts by mass of an epoxy resin containing 1 to 30 parts by mass of a dimer acid epoxy resin and 1 to 40 parts by mass of a liquid epoxy resin (excluding dimer acid epoxy resins); and
700 to 1700 parts by mass of a conductive filler, wherein
the conductive filler contains a conductive filler (A) having an average particle size (D50) measured by a laser diffraction scattering particle size distribution measurement method of 5 to 20 μm and a conductive filler (B) having an average particle size (D50) of 1 to 8 μm,
a rate ((A)/(B)) of the average particle size of the conductive filler (A) and the average particle size of the conductive filler (B) is 1.5 or more, and
a content rate ((A)/(B)) of the conductive filler (A) and the conductive filler (B) by mass rate is 1.0 to 50.0.

2. The thermally conductive composition according to claim 1, wherein the dimer acid epoxy resin is a glycidyl-modified compound of a dimer acid.

3. The thermally conductive composition according to claim 1 or 2, wherein the liquid epoxy resin is a glycidyl ether epoxy resin.

4. The thermally conductive composition according to claim 1, wherein the epoxy resin contains a glycidyl amine epoxy resin.

5. The thermally conductive composition according to claim 2, wherein the liquid epoxy resin is a glycidyl ether epoxy resin.

6. The thermally conductive composition according to claim 2, wherein the epoxy resin contains a glycidyl amine epoxy resin.

7. The thermally conductive composition according to claim 3, wherein the epoxy resin contains a glycidyl amine epoxy resin.
